(19) United States
(12) Patent Application Publication
(10) Pub. No.: US 2026/0124846 A1
(43) Pub. Date: May 7, 2026

(54) BOOKBINDING SYSTEM AND BOOKBINDING APPARATUS

(71) Applicant: Horizon Inc., Shiga (JP)

(72) Inventors: Tomonori YACHI, Shiga (JP); Shigenobu Fukuda, Shiga (JP)

(21) Appl. No.: 19/379,141

(22) Filed: Nov. 4, 2025

(30) Foreign Application Priority Data
Nov. 6, 2024 (JP) 2024-194265

(51) Int. Cl. B42C 19/08; B42C 5/00; B42C 9/00; B42C 11/04

(52) U.S. Cl. CPC B42C 19/08; B42C 5/00; B42C 9/0006; B42C 11/04

(57) ABSTRACT

A bookbinding apparatus has: a first transport unit that transports a book along a first path; a gluing unit that glues the spine of the book transported along the first path; an attaching unit that attaches a cover to the spine of the glued book; a second transport unit that transports the book with the cover along a second path and discharges it to the transport apparatus; a book supply unit that supplies the book with the cover from the first path to the second path; and a casing accommodating the first transport unit, the gluing unit, the attaching unit, the second transport unit, and the book supply unit. The second path is longer than the distance between a position where the book is supplied from the book supply unit to the second path and a position where the book is discharged from the second path to the transport apparatus.

This application is based on Japanese Patent Application No. 2024-194265 filed on November 6, 2024, the contents of which are incorporated herein by reference in its entirety.

### BACKGROUND

### 1. TECHNICAL FIELD

The present disclosure relates to a bookbinding system and a bookbinding apparatus.

### 2. DESCRIPTION OF RELATED ART

Bookbinding systems are conventionally known that use a perfect-binding bookbinding apparatus to apply a glue to the spine of a book to attach a cover thereto, use a conveyer to transport the book perfect-bound by the perfect-binding bookbinding apparatus, and use a cutting apparatus to perform a cutting process on the book transported by the conveyer (see, for example, Japanese Patent Application Laid-Open No. 2021-30450). The bookbinding system disclosed in Japanese Patent Application Laid-Open No. 2021-30450 accumulates bound books transported from the bookbinding apparatus on an accumulating apparatus and transports the bound books to the cutting apparatus from the accumulating apparatus via a cooling conveyer apparatus.

In the bookbinding system disclosed in Japanese Patent Application Laid-Open No. 2021-30450, it is required to ensure a sufficient length as a transport distance of a cooling conveyer apparatus in order to sufficiently cool a glue applied to the spine of the bound book being transported by the cooling conveyer apparatus that transports the bound book from the perfect-binding bookbinding apparatus to the cutting apparatus.

However, a longer transport distance of the cooling conveyer apparatus needs a larger footprint for the entire bookbinding system, and this prevents a reduction in size of the bookbinding system.

### BRIEF SUMMARY

The present disclosure has been made in view of the above problem and intends to provide a bookbinding system and a bookbinding apparatus that can sufficiently cool a glue applied to the spine of a book and achieve a reduction in size with a shortened transport distance of a transport apparatus configured to transport a book from the bookbinding apparatus to a cutting apparatus.

The bookbinding system according to one aspect of the present disclosure is a bookbinding system including: a bookbinding apparatus; a cutting apparatus configured to perform a cutting process on a book bound by the bookbinding apparatus; and a transport apparatus configured to transport, to the cutting apparatus, the book discharged from the bookbinding apparatus. The bookbinding apparatus has a first transport unit configured to transport, along a first transport path, the book including a plurality of sheets, a gluing unit configured to glue a spine of the book transported along the first transport path, an attaching unit configured to attach an additional member to the spine of the book glued by the gluing unit, a second transport unit configured to transport the book along a second transport path, the additional member being attached to the book by the attaching unit, and discharge the book to the transport apparatus, a book supply unit configured to supply the book from the first transport path to the second transport path, the additional member being attached to the book, and a casing configured to accommodate the first transport unit, the gluing unit, the attaching unit, the second transport unit, and the book supply unit. The second transport path is longer than a straight-line distance between a supply position at which the book is supplied from the book supply unit to the second transport path and a discharge position at which the book is discharged from the second transport path to the transport apparatus.

According to the bookbinding system of one aspect of the present disclosure, when the first transport unit transports a book along the first transport path, the spine of the book is glued by the gluing unit, and the additional member is attached to the spine of the book by the attaching unit. The book with the additional member attached is supplied from the first transport path to the second transport path by the book supply unit, transported along the second transport path by the second transport unit, and discharged to the transport apparatus.

The first transport unit and the second transport unit are accommodated in a single casing together with the gluing unit, the attaching unit, and the book supply unit. Further, the second transport path is longer than the straight-line distance between the supply position and the discharge position. Thus, the transport distance of the second transport path is suitably ensured, and the glue on the spine of the book can be sufficiently cooled before the book is discharged from the casing to the transport apparatus. Accordingly, the transport distance of the transport apparatus configured to transport the book from the bookbinding apparatus to the cutting apparatus can be shortened to achieve a reduction in size of the bookbinding system.

The bookbinding system according to one aspect of the present disclosure may be configured such that the first transport path is to turn a direction of transporting the book from a first direction back to a second direction for transportation, the second direction being opposite to the first direction, and the second transport path is to turn a direction of transporting the book from the second direction back to the first direction for transportation.

According to the bookbinding system of the present configuration, by using both the first transport path configured for transporting a book to turn from the first direction back to the second direction and the second transport path configured for transporting the book to turn from the second direction back to the first direction, it is possible to ensure a sufficient transport distance of the book inside the casing of the bookbinding apparatus to sufficiently cool the glue on the spine of the book while reducing the size of the bookbinding apparatus.

The bookbinding system according to one aspect of the present disclosure may be configured such that the first transport path and the second transport path are arranged such that at least partial regions of the first transport path and the second transport path overlap each other when the casing is viewed in planar view.

According to the bookbinding system of the present configuration, since at least partial regions of the first transport path and the second transport path overlap each other when the casing is viewed in planar view, the installation area of the bookbinding apparatus can be reduced while a sufficient transport distance of a book is ensured in the casing of the bookbinding apparatus.

The bookbinding system according to one aspect of the present disclosure may be configured such that the first transport path and the second transport path are arranged such that the second transport path surrounds the first transport path when the casing is viewed in planar view.

According to the bookbinding system of the present configuration, since the second transport path is arranged so as to surround the first transport path when the casing is viewed in planar view, the height of the bookbinding apparatus can be maintained low while a sufficient transport distance of the book is ensured in the casing of the bookbinding apparatus.

The bookbinding system according to one aspect of the present disclosure may be configured such that the book supply unit has a motion mechanism (92) configured to move the book in a height direction from the first transport path to the second transport path.

According to the bookbinding system of the present configuration, the use of the motion mechanism of the book supply unit makes it possible to suitably perform the supply of a book from the first transport path to the second transport path where the first and second transport paths are arranged at different positions in the height direction.

The bookbinding system according to one aspect of the present disclosure may be configured such that the bookbinding apparatus has a cooling unit configured to cool the book transported along the second transport path.

According to the bookbinding system of the present configuration, the book transported along the second transport path is cooled by the cooling unit, and thereby the glue on the spine of a book can be sufficiently solidified.

The bookbinding system according to one aspect of the present disclosure may be configured such that the bookbinding apparatus has a discharge unit, the book being discharged from the second transport unit to the discharge unit, and the second transport unit discharges the book to either the transport apparatus or the discharge unit.

According to the bookbinding system of the present configuration, a book transported by the second transport unit can be selectively discharged to either the transport apparatus or the discharge unit.

The bookbinding apparatus according to one aspect of the present disclosure includes: a first transport unit configured to transport, along a first transport path, a book including a plurality of sheets; a gluing unit configured to glue a spine of the book transported along the first transport path; an attaching unit configured to attach an additional member to the spine of the book glued by the gluing unit; a second transport unit configured to transport the book along a second transport path, the additional member being attached to the book by the attaching unit, and discharge the book; a book supply unit configured to supply the book from the first transport path to the second transport path, the additional member being attached to the book; and a casing configured to accommodate the first transport unit, the gluing unit, the attaching unit, the second transport unit, and the book supply unit. The second transport path is longer than a straight-line distance between a supply position at which the book is supplied from the book supply unit to the second transport path and a discharge position at which the book is discharged from the second transport path.

According to the bookbinding apparatus of one aspect of the present disclosure, when the first transport unit transports a book along the first transport path, the spine of the book is glued by the gluing unit, and the additional member is attached to the spine of the book by the attaching unit. The book with the additional member attached is supplied from the first transport path to the second transport path by the book supply unit, transported along the second transport path by the second transport unit, and discharged outside.

The first transport unit and the second transport unit are accommodated in a single casing together with the gluing unit, the attaching unit, and the book supply unit. Further, the second transport path is longer than the straight-line distance between the supply position and the discharge position. Thus, the transport distance of the second transport path is suitably ensured, and the glue on the spine of the book can be sufficiently cooled before the book is discharged from the casing to the transport apparatus. Accordingly, the transport distance of the transport apparatus configured to transport the book from the bookbinding apparatus to the cutting apparatus can be shortened.

A bookbinding system according to one aspect of the present disclosure is a bookbinding system including: a bookbinding apparatus; a cutting apparatus configured to perform a cutting process on a book bound by the bookbinding apparatus; and a transport apparatus configured to transport, to the cutting apparatus, the book discharged from the bookbinding apparatus. The cutting apparatus has a first transport unit configured to transport, along a first transport path, the book supplied from the transport apparatus, a second transport unit configured to transport the book along a second transport path, a cutting unit configured to perform a cutting process on the book transported by the second transport unit, a book supply unit configured to supply the book from the first transport path to the second transport path, and a casing configured to accommodate the first transport unit, the second transport unit, the cutting unit, and the book supply unit. The first transport path is longer than a straight-line distance between a supply position at which the book is supplied from the transport apparatus to the first transport path at the supply position and a handover position at which the book is handed over from the first transport path to the book supply unit.

According to the bookbinding system of one aspect of the present disclosure, the first transport unit and the second transport unit are accommodated in a single casing together with cutting unit and the book supply unit. Further, the first transport path is longer than the straight-line distance between the supply position and the handover position. Thus, the transport distance of the first transport path is suitably ensured, and the glue on the spine of the book can be sufficiently cooled before the book is subjected to a cutting process by the cutting unit. Accordingly, the transport distance of the transport apparatus configured to transport the book from the bookbinding apparatus to the cutting apparatus can be shortened to achieve a reduction in size of the bookbinding system.

According to the present disclosure, it is possible to provide a bookbinding system and a bookbinding apparatus that can sufficiently cool a glue applied to the spine of a book and achieve a reduction in size with a shortened transport distance of a transport apparatus configured to transport a book from the bookbinding apparatus to a cutting apparatus.

### BRIEF DESCRIPTION OF THE SEVERAL VIEWS OF THE DRAWINGS

FIG. 1 is a perspective view illustrating a bookbinding system according to a first embodiment of the present disclosure.

FIG. 2 is a plan view illustrating the bookbinding system according to the first embodiment of the present disclosure, which illustrates a first transport path of a bookbinding apparatus.

FIG. 3 is a plan view illustrating the bookbinding system according to the first embodiment of the present disclosure, which illustrates a second transport path of the bookbinding apparatus.

FIG. 4 is a perspective view schematically illustrating the overall configuration of the bookbinding apparatus.

FIG. 5 is a perspective view illustrating an operation of a book supply unit, which illustrates a state where a book is arranged on the first transport path.

FIG. 6 is a perspective view illustrating an operation of the book supply unit, which illustrates a state where a book has been supplied to the second transport path.

FIG. 7 is a perspective view illustrating an operation of the book supply unit, which illustrates a state where a book is transported by a second transport unit.

FIG. 8 is a perspective view illustrating a bookbinding system according to a second embodiment of the present disclosure.

FIG. 9 is a plan view illustrating the bookbinding system according to the second embodiment of the present disclosure, which illustrates the second transport path of the bookbinding apparatus.

FIG. 10 is a plan view illustrating a bookbinding system according to a third embodiment of the present disclosure, which illustrates the second transport path of the bookbinding apparatus.

FIG. 11 is a plan view illustrating a bookbinding system according to a fourth embodiment of the present disclosure, which illustrates the first transport path and a part of the second transport path of the bookbinding apparatus.

FIG. 12 is a plan view illustrating a bookbinding system according to a fifth embodiment of the present disclosure, which illustrates the first transport path and a part of the second transport path of the bookbinding apparatus.

FIG. 13 is a plan view illustrating a bookbinding system according to a sixth embodiment of the present disclosure, which illustrates the second transport path of the bookbinding apparatus.

FIG. 14 is a plan view illustrating a bookbinding system according to a seventh embodiment of the present disclosure, which illustrates a first transport path of a cutting apparatus.

FIG. 15 is a plan view illustrating the bookbinding system according to the seventh embodiment of the present disclosure, which illustrates a second transport path of the cutting apparatus.

### DETAILED DESCRIPTION

### First Embodiment

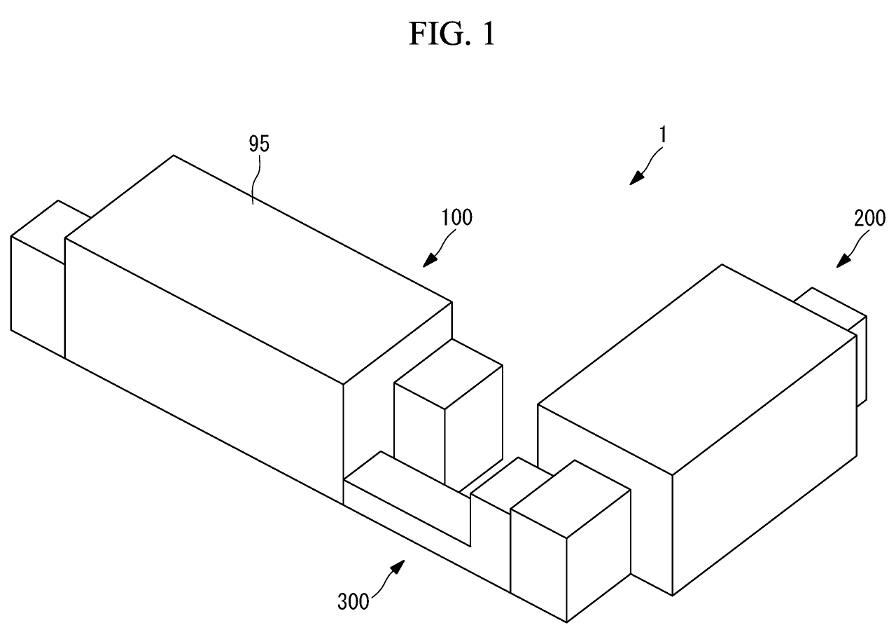

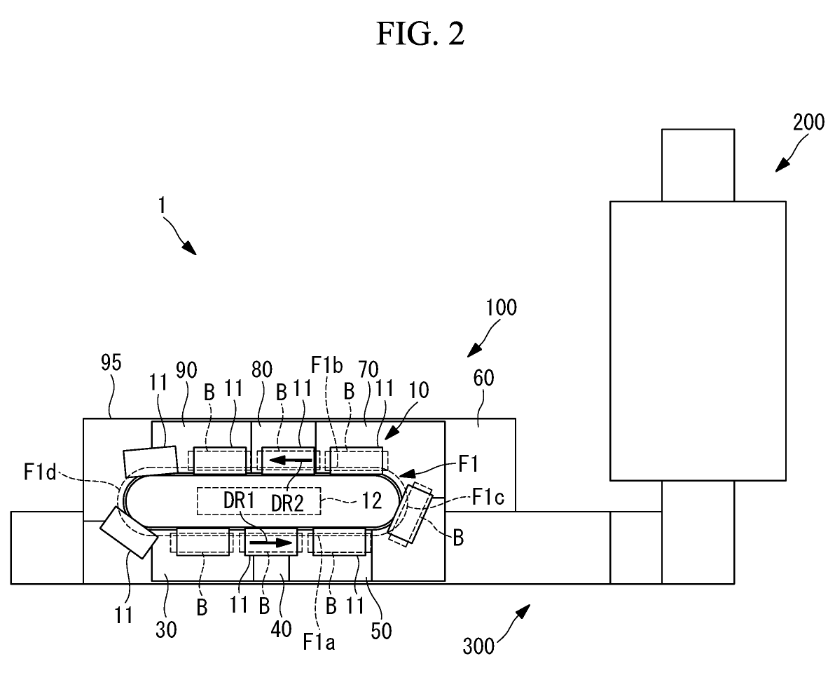

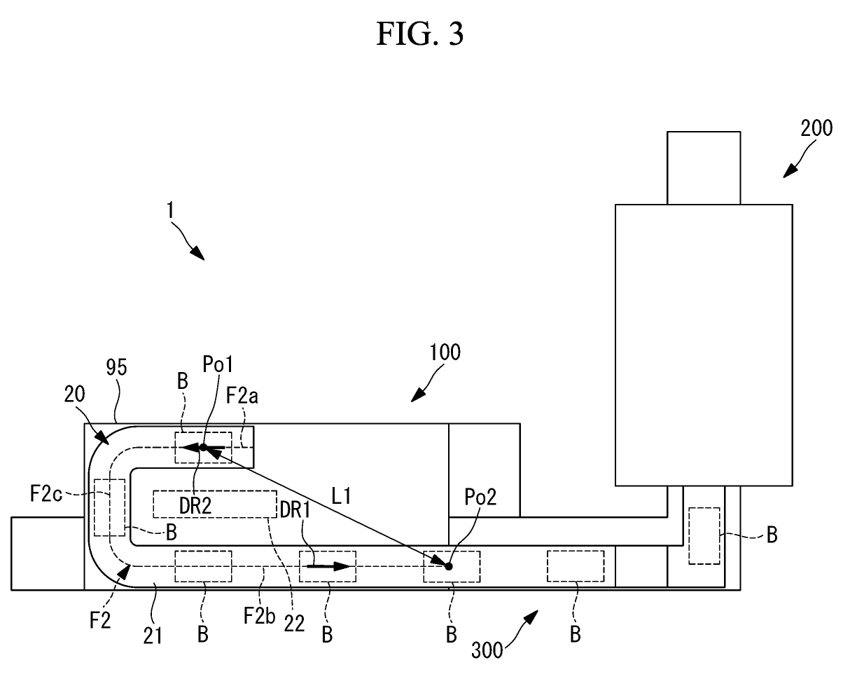

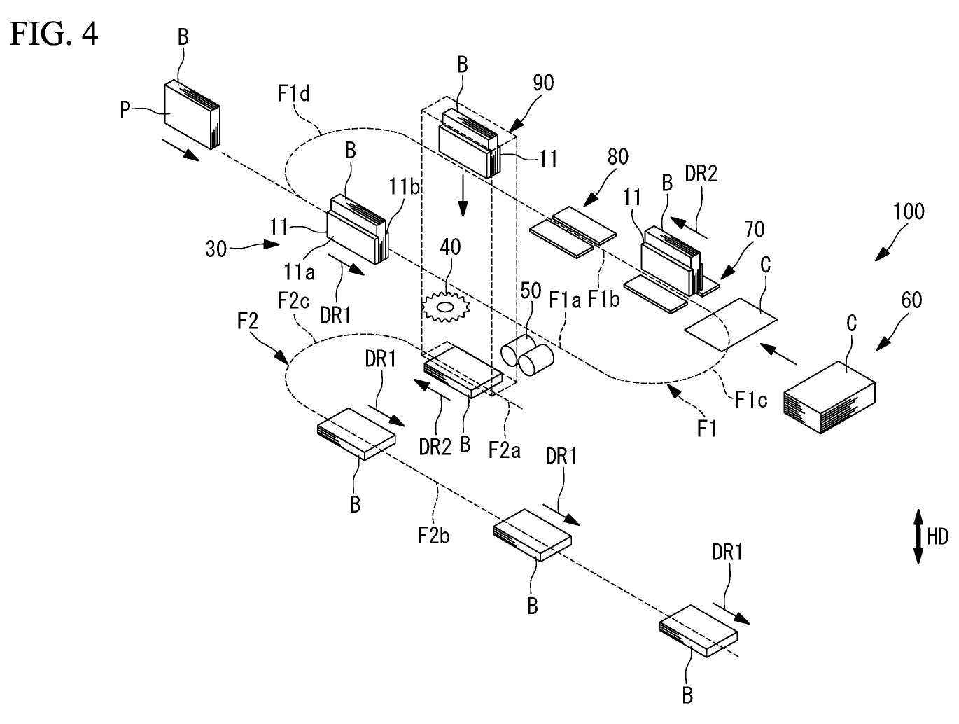

A bookbinding system 1 according to the first embodiment of the present disclosure will be described below with reference to the drawings. FIG. 1 is a perspective view illustrating the bookbinding system 1 according to the first embodiment of the present disclosure. FIG. 2 is a plan view illustrating the bookbinding system 1 according to the first embodiment of the present disclosure, which illustrates a first transport path F1 of a bookbinding apparatus 100. FIG. 3 is a plan view illustrating the bookbinding system 1 according to the first embodiment of the present disclosure, which illustrates a second transport path F2 of the bookbinding apparatus 100. FIG. 4 is a perspective view schematically illustrating the overall configuration of the bookbinding apparatus 100.

In FIG. 2, the upper portion of a casing 95 illustrated in FIG. 1 is omitted, and a part near the first transport path F1 inside the casing 95 is illustrated. In FIG. 3, the upper portion of the casing 95 illustrated in FIG. 1 is omitted, and a part near the second transport path F2 inside the casing 95 is illustrated. The internal space of the casing 95 illustrated in FIG. 2 is arranged above the internal space of the casing 95 illustrated in FIG. 3.

As illustrated in FIG. 1 to FIG. 3, the bookbinding system 1 according to the present embodiment includes the bookbinding apparatus (perfect-binding bookbinding apparatus) 100, a cutting apparatus 200 configured to perform a cutting process on the book B perfect-bound by the bookbinding apparatus 100, and a transport apparatus 300 configured to transport, to the cutting apparatus 200, the book B discharged from the bookbinding apparatus 100.

As illustrated in FIG. 1 to FIG. 4, the bookbinding apparatus 100 has a first transport unit 10, a second transport unit 20, a book insertion unit 30, a milling unit 40, a gluing unit 50, a cover supply unit 60, a cover attaching unit 70, a nipping unit 80, a book supply unit 90, and a casing 95.

The first transport unit 10 is a device configured to transport the book B, which includes a plurality of sheets P, along the first transport path F1. The first transport unit 10 has one or two or more (nine as illustrated in FIG. 2 in the present embodiment) clampers 11 configured to grip and hold the book B in a standing state and a transport mechanism 12 configured to move the clampers 11 along the first transport path F1. Each clamper 11 has a pair of clamp plates 11a, 11b.

As illustrated in FIG. 2 and FIG. 4, the first transport path F1 has a loop shape formed of a straight path F1a and a straight path F1b arranged spaced apart from each other in a vertical plane and each extending horizontally and of arcuate paths F1c and F1d each connecting ends of the straight path F1a and the straight path F1b to each other. Further, although not illustrated, a guide is provided along the first transport path F1. The clamper 11 is attached slidably to this guide and moved along the first transport path F1 while being guided by the guide.

The first transport unit 10 drives the clampers 11 by the transport mechanism 12 and thereby moves the book B in one direction (counterclockwise in FIG. 2 and FIG. 4) along the first transport path F1. The first transport path F1 turns the direction of transporting the book B by 180 degrees from the first direction DR1 on the straight path F1a back to the second direction DR2 on the straight path F1b for the transportation. The second direction DR2 is the direction opposite to the first direction DR1 by 180 degrees.

The second transport unit 20 is a device configured to transport, along the second transport path F2, the book B to which the cover C has been attached by the cover attaching unit 70 and discharge the book B to the transport apparatus 300. The second transport unit 20 has a conveyer belt 21 and a transport mechanism 22.

As illustrated in FIG. 3 and FIG. 4, the second transport path F2 has a U-shape formed of a straight path F2a and a straight path F2b arranged spaced apart from each other in a vertical plane and each extending horizontally and of an arcuate path F2c connecting ends of the straight path F2a and the straight path F2b to each other. As illustrated in FIG. 3, the second transport path F2 is longer than the straight-line distance L1 between a supply position Po1 at which the book B is supplied from the book supply unit 90 to the second transport path F2 and a discharge position Po2 at which the book B is discharged from the second transport path F2 to the transport apparatus 300.

The second transport unit 20 drives the conveyer belt 21 by the transport mechanism 22 to move the book B in one direction (counterclockwise in FIG. 3 and FIG. 4) along the second transport path F2. The second transport path F2 turns the direction of transporting the book B by 180 degrees from the second direction DR2 on the straight path F2a back to the first direction DR1 on the straight path F2b to transport the book B.

As illustrated in FIG. 2 to FIG. 4, the first transport path F1 and the second transport path F2 are arranged such that at least partial regions thereof overlap each other when the casing 95 is viewed in planar view. In the internal space of the casing 95, the first transport path F1 is arranged higher in the height direction HD than the second transport path F2. In such a way, the first transport path F1 and the second transport path F2 are arranged at different positions in the height direction HD inside the casing 95.

The book insertion unit 30 is a device configured to insert the externally supplied book B into the clampers 11. The book insertion unit 30 inserts the books B into the plurality of clampers 11, which are transported along the first transport path F1, respectively, in a one-to-one manner. The clamper 11 holds the book B, which has been inserted by the book insertion unit 30, by a pair of clamp plates 11a, 11b. Note that the bookbinding apparatus 100 of the present embodiment is configured to enable an operator to manually insert the book B into the clamper 11.

The milling unit 40 is a device configured to cut and scrape the spine of the book B. Once the spine of the book B is cut and scraped, a glue enters the cut and scraped portion, and this can enhance the adhesiveness at the spine of the book B. The first transport unit 10 transports the book B processed at the milling unit 40 to the gluing unit 50.

The gluing unit 50 is a device configured to heat a glue by a heater (not illustrated) and apply the glue to the spine of the book B by using a roller. The first transport unit 10 transports the book B processed by the gluing unit 50 from the straight path F1a to the cover attaching unit 70 on the straight path F1b via the arcuate path F1c.

The cover supply unit 60 is a device configured to transport a plurality of prepared covers C one by one to supply the covers C to the cover attaching unit 70.

The cover attaching unit 70 is a device configured to attach the cover C fed from the cover supply unit 60 to the spine of the book B to which the glue has been applied, namely, perform the attaching to obtain the book B to which the cover has been attached. The first transport unit 10 transports the book B with the cover C attached thereto to the nipping unit 80 along the first transport path F1. Although the bookbinding apparatus 100 of the present embodiment includes the cover attaching unit 70 configured to attach the cover C to the spine of the book B to which a glue has been applied, other forms may be employed. For example, the bookbinding apparatus 100 may include an additional member attaching unit configured to attach an additional member such as a gausing strip to the spine of the book B to which a glue has been applied.

The nipping unit 80 is a device configured to push the spine portion of the book B in the direction orthogonal to the second direction DR2 from the spine side and both the end sides in order to enhance the adhesiveness between the book B and the cover C. The first transport unit 10 transports the book B whose spine is pushed by the nipping unit 80 to the book supply unit 90.

The book supply unit 90 is a device configured to supply, from the first transport path F1 to the second transport path F2, the book B to which the cover C has been attached. The book supply unit 90 moves the book B handed over from the clamper 11 on the first transport path F1 from above to below in the height direction HD and supplies the book B to the second transport path F2.

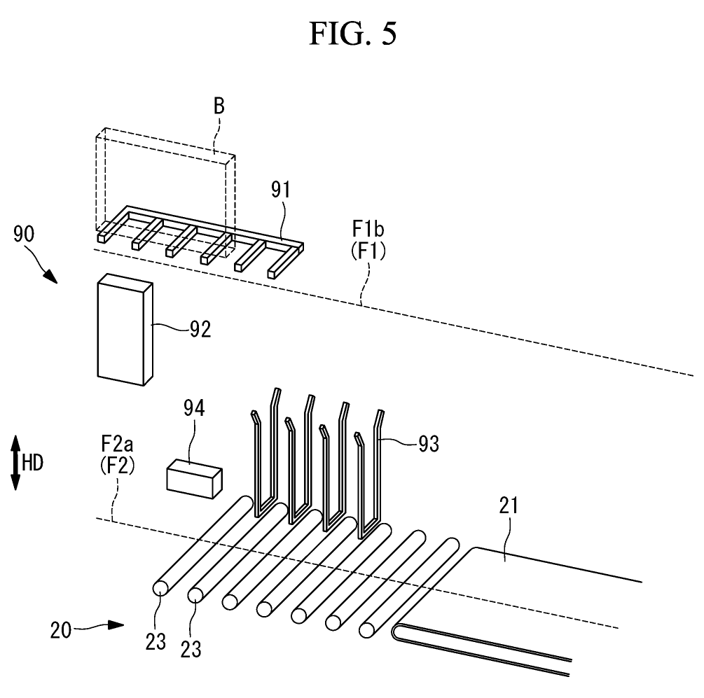

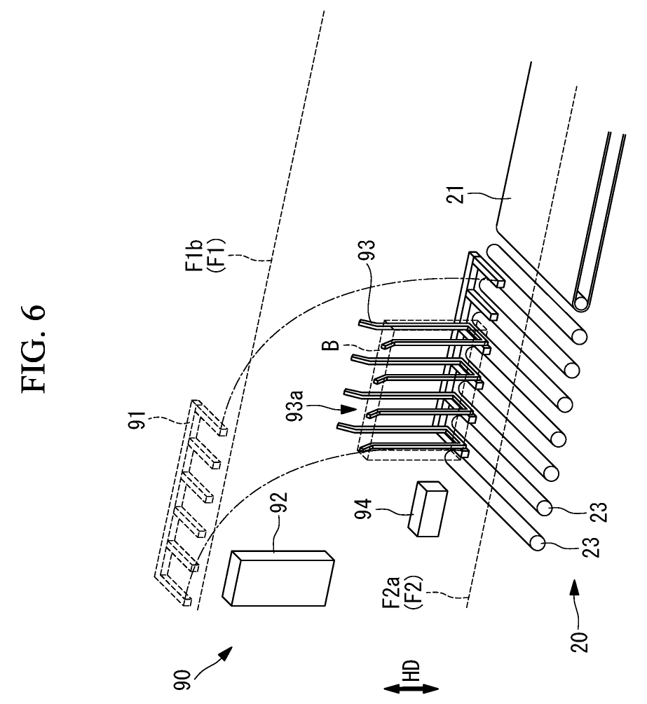

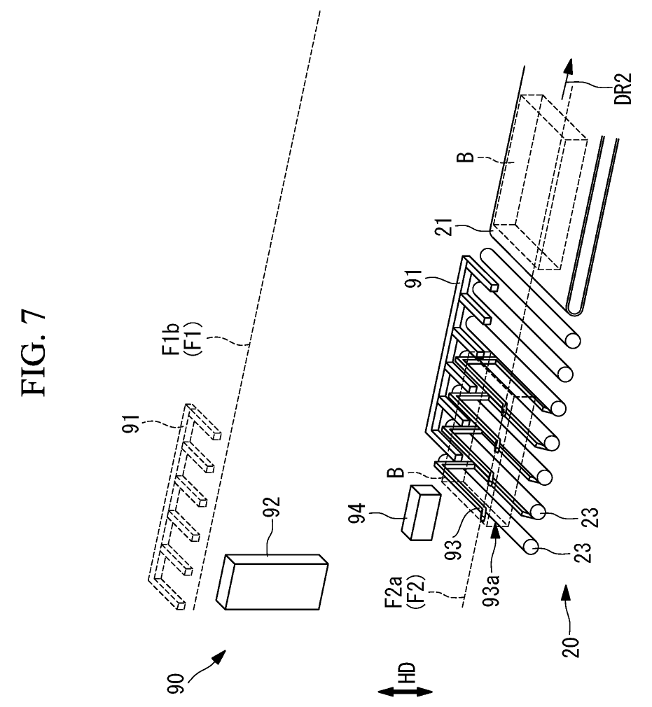

The book supply unit 90 will now be described with reference to FIG. 5 to FIG. 7. FIG. 5 to FIG. 7 are perspective views illustrating the operation of the book supply unit 90. FIG. 5 illustrates a state where the book B is arranged on the first transport path F1. FIG. 6 illustrates a state where the book B has been supplied to the second transport path F2. FIG. 7 illustrates a state where the book B is transported by the second transport unit 20.

As illustrated in FIG. 5 to FIG. 7, the book supply unit 90 has a first loading unit 91, a motion mechanism 92 configured to move the first loading unit 91 in the height direction HD, a second loading unit 93, and a pivoting mechanism 94 configured to pivot the second loading unit 93 about a straight line parallel to the straight path F2a. The motion mechanism 92 moves the position in the height direction HD of the first loading unit 91 to be lowered from the position illustrated in FIG. 5 to the position illustrated in FIG. 6 and thereby moves the book B from the first transport path F1 to the second transport path F2 in the height direction HD.

As illustrated in FIG. 6, when accepting the book B loaded on the first loading unit 91 in the second loading unit 93, the pivoting mechanism 94 arrange the second loading unit 93 so that an opening 93a that can accept the book B in the second loading unit 93 is arranged above in the height direction HD. After accepting the book B in the second loading unit 93, the pivoting mechanism 94 pivots the second loading unit 93 into the state illustrated in FIG. 7.

In the state illustrated in FIG. 7, the second transport unit 20 is in a state where the second transport unit 20 is supported by a plurality of transport rollers 23 driven by the transport mechanism 22. The second transport unit 20 drives the plurality of transport rollers 23 by the transport mechanism 22 and thereby transports the book B loaded on the second loading unit 93 to the conveyer belt 21 along the second direction DR2. The conveyer belt 21 driven by the transport mechanism 22 transports the book B along the second transport path F2 and supplies the book B to the transport apparatus 300.

The casing 95 is a member that accommodates the first transport unit 10, the second transport unit 20, the book insertion unit 30, the milling unit 40, the gluing unit 50, the cover supply unit 60, the cover attaching unit 70, the nipping unit 80, and the book supply unit 90 therein. The casing 95 is arranged so as to cover the entire region on the upper side of the first transport unit 10 and the entire region on the upper side of the second transport unit 20.

The effects and advantages achieved by the bookbinding system 1 of the present embodiment described above will be described.

According to the bookbinding system 1 of the present embodiment, when the first transport unit 10 transports the book B along the first transport path F1, the spine of the book B is glued by the gluing unit 50, and the cover C is attached to the spine of the book B by the cover attaching unit 70. The book B to which the cover C has been attached is supplied from the first transport path F1 to the second transport path F2 by the book supply unit 90, transported along the second transport path F2 by the second transport unit 20, and discharged to the transport apparatus 300.

The first transport unit 10 and the second transport unit 20 are accommodated in the single casing 95 together with the gluing unit 50, the cover attaching unit 70, and the book supply unit 90. Further, the second transport path F2 is longer than the straight-line distance L1 between the supply position Po1 and the discharge position Po2. Thus, the transport distance of the second transport path F2 is suitably ensured, and the glue on the spine of the book B can be sufficiently cooled before the book B is discharged from the casing 95 to the transport apparatus 300. Accordingly, the transport distance of the transport apparatus 300 configured to transport the book B from the bookbinding apparatus 100 to the cutting apparatus 200 can be shortened to achieve a reduction in size of the bookbinding system 1.

According to the bookbinding system 1 of the present embodiment, by using both the first transport path F1 configured for transporting the book B to turn from the first direction DR1 back to the second direction DR2 and the second transport path F2 configured for transporting the book B to turn from the second direction DR2 back to the first direction DR1, it is possible to ensure a sufficient transport distance of the book B inside the casing 95 of the bookbinding apparatus 100 to sufficiently cool the glue on the spine of the book B while reducing the size of the bookbinding apparatus 100.

According to the bookbinding system 1 of the present embodiment, since at least partial regions of the first transport path F1 and the second transport path F2 overlap each other when the casing 95 is viewed in planar view, the footprint of the bookbinding apparatus 100 can be reduced while a sufficient transport distance of the book B is ensured in the casing 95 of the bookbinding apparatus 100.

According to the bookbinding system 1 of the present embodiment, the use of the motion mechanism 92 of the book supply unit 90 makes it possible to suitably perform the supply of the book B from the first transport path F1 to the second transport path F2 where the first and second transport paths F1 and F2 are arranged at different positions in the height direction HD.

### Second Embodiment

Next, a bookbinding system 1A of the second embodiment of the present disclosure will be described. The present embodiment is a modified example to the first embodiment and assumed to be the same as the first embodiment except where specifically described below, and the description thereof will be omitted below.

In the bookbinding system 1 of the first embodiment, the first transport path F1 and the second transport path F2 are arranged such that at least partial regions thereof overlap each other when the casing 95 is viewed in planar view. On the other hand, in the bookbinding system 1A of the present embodiment, the first transport path F1 and the second transport path F2 are arranged such that the second transport path F2 surrounds the first transport path F1 when the casing 95 is viewed in planar view.

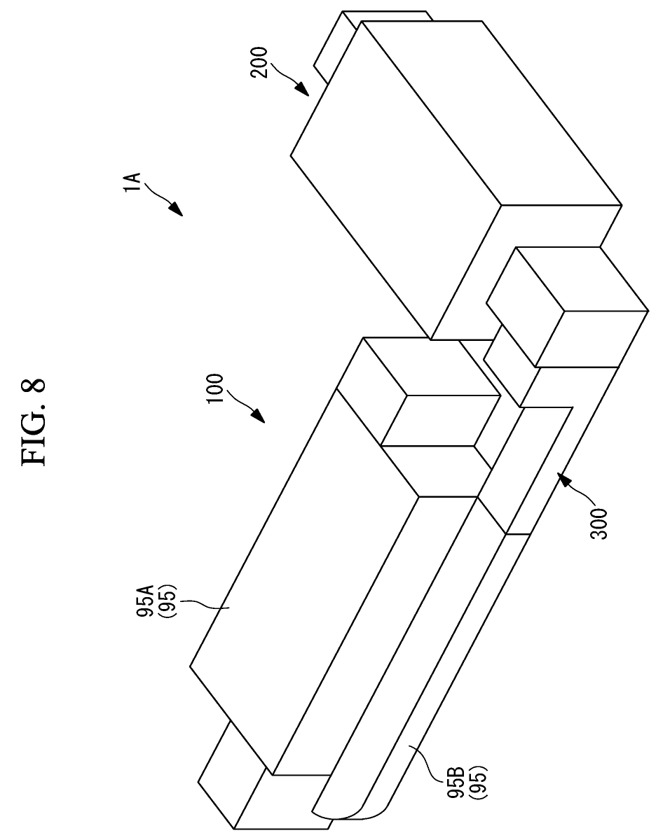

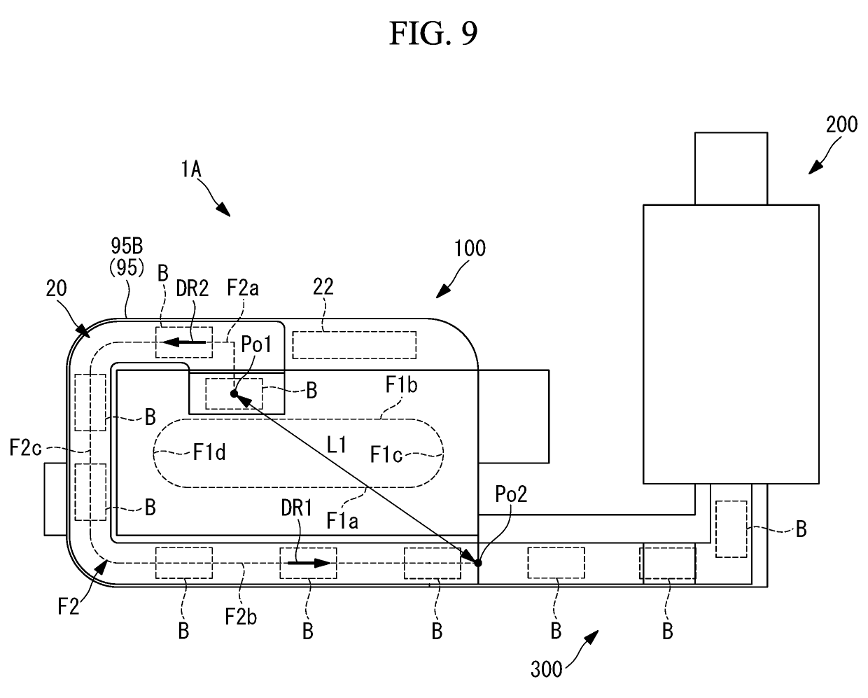

FIG. 8 is a perspective view illustrating the bookbinding system 1A according to the second embodiment of the present disclosure. FIG. 9 is a plan view illustrating the bookbinding system 1A according to the second embodiment of the present disclosure, which illustrates the second transport path F2 of the bookbinding apparatus 100.

As illustrated in FIG. 8, the casing 95 of the bookbinding system 1A of the present embodiment has a first casing 95A and a second casing 95B. The first casing 95A is a casing that accommodates the first transport unit 10, the book insertion unit 30, the milling unit 40, the gluing unit 50, the cover supply unit 60, the cover attaching unit 70, the nipping unit 80, and the book supply unit 90 therein. The second casing 95B is a casing that accommodates the second transport unit 20 therein.

As illustrated in FIG. 9, in the bookbinding system 1A of the present embodiment, the first transport path F1 and the second transport path F2 are arranged such that the second transport path F2 surrounds the first transport path F1 when the casing 95 is viewed in planar view. As illustrated in FIG. 9, the second transport path F2 is longer than the straight-line distance L1 between the supply position Po1 at which the book B is supplied from the book supply unit 90 to the second transport path F2 and the discharge position Po2 at which the book B is discharged from the second transport path F2 to the transport apparatus 300.

According to the bookbinding system 1A of the present embodiment, since the second transport path F2 is arranged so as to surround the first transport path F1 when the casing 95 is viewed in planar view, the height of the bookbinding apparatus 100 can be maintained low while a sufficient transport distance of the book B is ensured in the casing 95 of the bookbinding apparatus 100.

### Third Embodiment

Next, a bookbinding system 1B of the third embodiment of the present disclosure will be described. The present embodiment is a modified example to the first embodiment and assumed to be the same as the first embodiment except where specifically described below, and the description thereof will be omitted below.

The second transport path F2 of the first embodiment has a U-shape formed of the straight path F2a and the straight path F2b arranged spaced apart from each other in a vertical plane and each extending horizontally and the arcuate path F2c connecting ends of the straight path F2a and the straight path F2b to each other. On the other hand, the second transport path F2 of the present embodiment is formed of the straight path F2a extending horizontally and an S-shaped arcuate path F2c connecting ends of the straight path F2a and the straight path 310 of the transport apparatus 300 to each other.

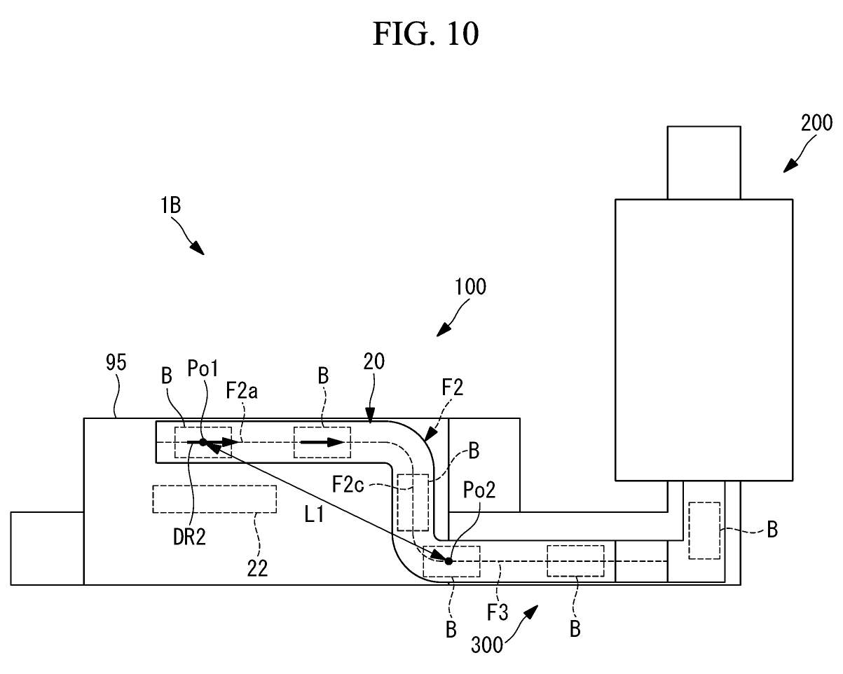

FIG. 10 is a plan view illustrating the bookbinding system 1B according to the third embodiment of the present disclosure, which is a diagram illustrating the second transport path F2 of the bookbinding apparatus 100. As illustrated in FIG. 10, the second transport path F2 is formed of the straight path F2a extending horizontally and the arcuate path F2c connecting ends of the straight path F2a and the straight path 310 of the transport apparatus 300 to each other. As illustrated in FIG. 10, the second transport path F2 is longer than the straight-line distance L1 between the supply position Po1 at which the book B is supplied from the book supply unit 90 to the second transport path F2 and the discharge position Po2 at which the book B is discharged from the second transport path F2 to the transport apparatus 300.

According to the bookbinding system 1B of the present embodiment, the transport distance of the second transport path F2 having the straight path F2a and the arcuate path F2c is suitably ensured, and the glue on the spine of the book B can be sufficiently cooled before the book B is discharged from the casing 95 to the transport apparatus 300. Accordingly, the transport distance of the transport apparatus 300 configured to transport the book B from the bookbinding apparatus 100 to the cutting apparatus 200 can be shortened to achieve a reduction in size of the bookbinding system 1.

### Fourth Embodiment

Next, a bookbinding system 1C of the fourth embodiment of the present disclosure will be described. The present embodiment is a modified example to the first embodiment and assumed to be the same as the first embodiment except where specifically described below, and the description thereof will be omitted below.

In the first embodiment, the casing 95 that accommodates the second transport unit 20 therein is arranged so as to cover the entire region on the upper side of the first transport unit 10 and the entire region on the upper side of the second transport unit 20. On the other hand, the casing 95 of the present embodiment is arranged so as to open a partial region on the upper side of the second transport unit 20 and cover the remaining region.

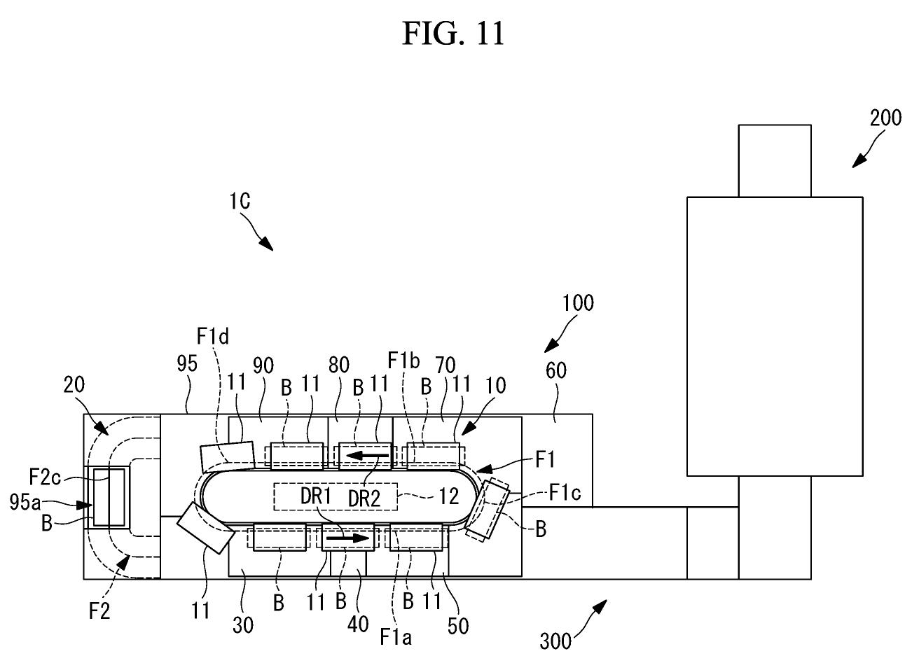

FIG. 11 is a plan view illustrating the bookbinding system 1C according to the fourth embodiment of the present disclosure, which is a diagram illustrating a part of the first transport path F1 and the second transport path F2 of the bookbinding apparatus 100. As illustrated in FIG. 11, the casing 95 of the present embodiment has an opening 95a that opens a partial region on the upper side of the second transport unit 20. The casing 95 is arranged so as to cover the remaining region on the upper side of the second transport unit 20 than the opening 95a.

### Fifth Embodiment

Next, a bookbinding system 1D of the fifth embodiment of the present disclosure will be described. The present embodiment is a modified example to the first embodiment and assumed to be the same as the first embodiment except where specifically described below, and the description thereof will be omitted below.

In the first embodiment, the casing 95 that accommodates the second transport unit 20 therein is arranged so as to cover the entire region on the upper side of the first transport unit 10 and the entire region on the upper side of the second transport unit 20. On the other hand, the casing 95 of the present embodiment is arranged so as to open a partial region on the upper side of the second transport unit 20 and cover the remaining region.

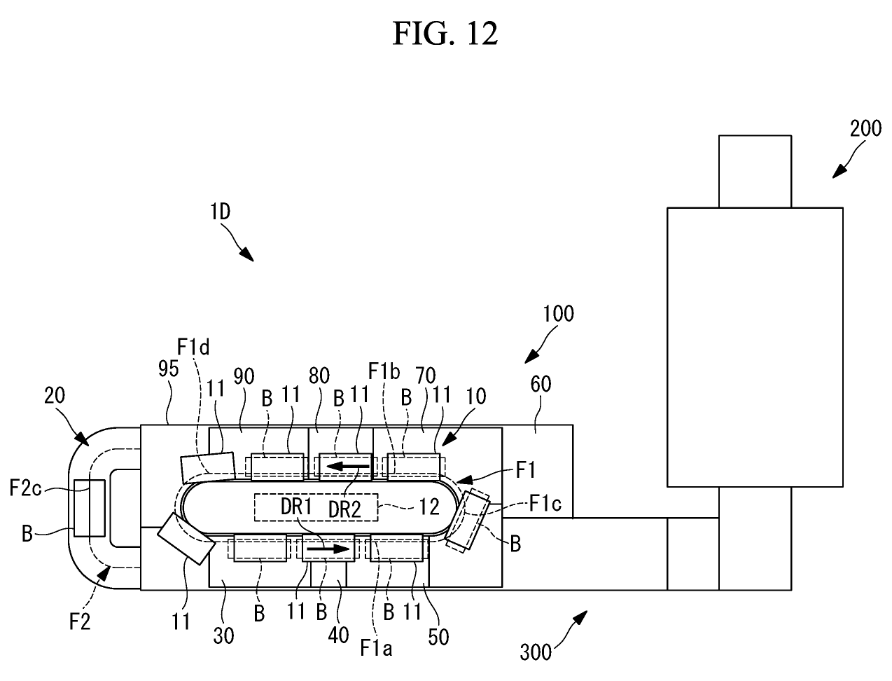

FIG. 12 is a plan view illustrating the bookbinding system 1D according to the fifth embodiment of the present disclosure, which is a diagram illustrating a part of the first transport path F1 and the second transport path F2 of the bookbinding apparatus 100. As illustrated in FIG. 12, the casing 95 of the present embodiment does not cover and exposes a partial region on the upper side of the second transport unit 20 to outside. The casing 95 is arranged so as to cover the remaining region on the upper side of the second transport unit 20 than the portion exposed outside the second transport unit 20. The second transport unit 20 discharges the book B out of the casing 95, then pulls the book B into the casing 95 again, and supplies the book B to the transport apparatus 300.

### Sixth Embodiment

Next, a bookbinding system 1E of the sixth embodiment of the present disclosure will be described. The present embodiment is a modified example to the first embodiment and assumed to be the same as the first embodiment except where specifically described below, and the description thereof will be omitted below.

The second transport path F2 of the first embodiment is for supplying all the books B supplied from the first transport path F1 to the transport apparatus 300. On the other hand, the second transport path F2 of the present embodiment is for supplying the books B supplied from the first transport path F1 to either the transport apparatus 300 or the discharge unit 400.

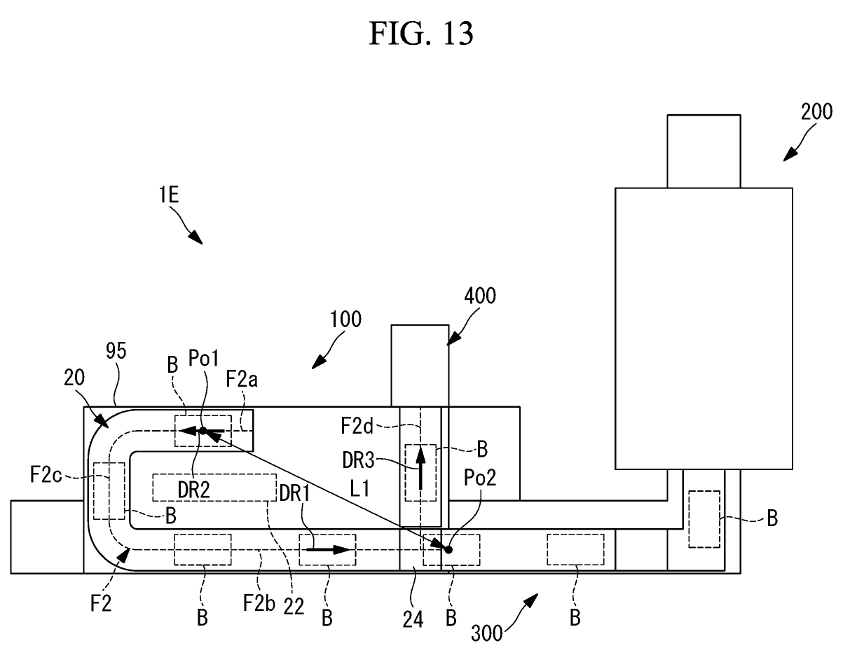

FIG. 13 is a plan view illustrating the bookbinding system 1E according to the sixth embodiment of the present disclosure, which is a diagram illustrating the second transport path F2 of the bookbinding system 1E. As illustrated in FIG. 13, the second transport path F2 is formed of the straight path F2a and the straight path F2b arranged spaced apart from each other in a vertical plane extending horizontally, respectively, the arcuate path F2c connecting ends of the straight path F2a and the straight path F2b to each other, and a straight path F2d branched from the straight path F2b at a part near the discharge position Po2.

As illustrated in FIG. 13, the second transport unit 20 of the present embodiment includes a transport direction switching unit 24. In accordance with an instruction from a control unit (not illustrated) of the bookbinding apparatus 100, the transport direction switching unit 24 switches whether to transport the book B in the first direction DR1 for supplying the book B to the transport apparatus 300 or to transport the book B in the third direction DR3 for discharging the book B to the discharge unit 400 of the bookbinding apparatus 100. When the transport direction switching unit 24 transports the book B in the first direction DR1, the book B is supplied to the transport apparatus 300. When the transport direction switching unit 24 transports the book B in the third direction DR3, the book B is supplied to the discharge unit 400.

### Seventh Embodiment

Next, a bookbinding system 1F of the seventh embodiment of the present disclosure will be described. The present embodiment is a modified example to the first embodiment and assumed to be the same as the first embodiment except where specifically described below, and the description thereof will be omitted below.

In the first embodiment, the second transport path F2 of the bookbinding apparatus 100 is longer than the straight-line distance L1 between the supply position Po1 and the discharge position Po2 and sufficiently cools the glue on the spine of the book B before the book B is discharged from the casing 95 to the transport apparatus 300. On the other hand, in the present embodiment, the first transport path F3 of the cutting apparatus 200 is longer than the straight-line distance L2 between a supply position Po3 at which the book B is supplied from the transport apparatus 300 to the first transport path F3 and a handover position Po4 at which the book B is handed over from the first transport path F3 to a book supply unit 290, and thereby the glue on the spine of the book B is sufficiently cooled before the cutting process is performed.

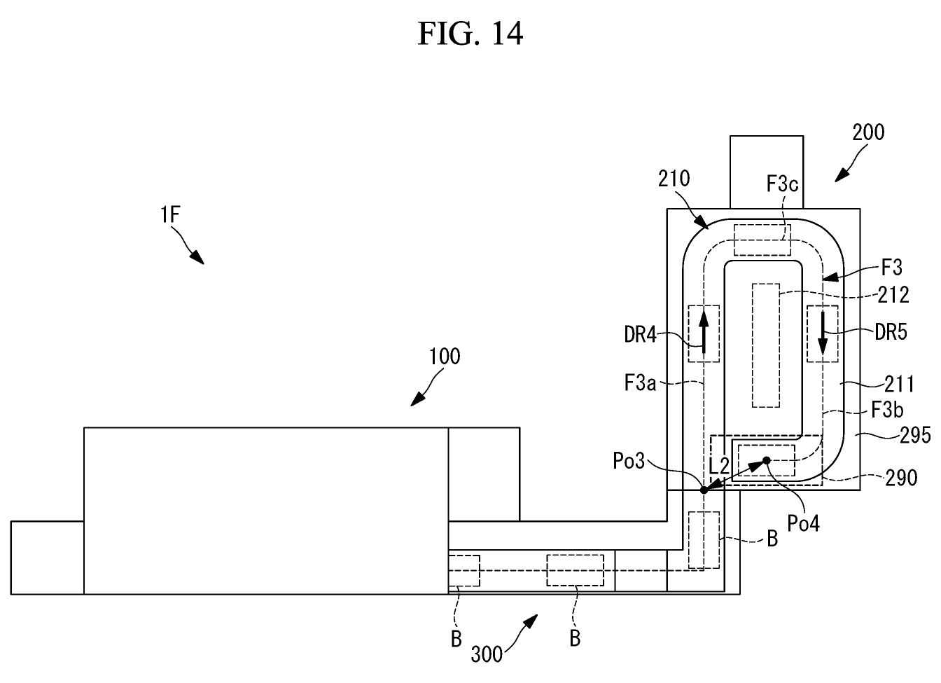

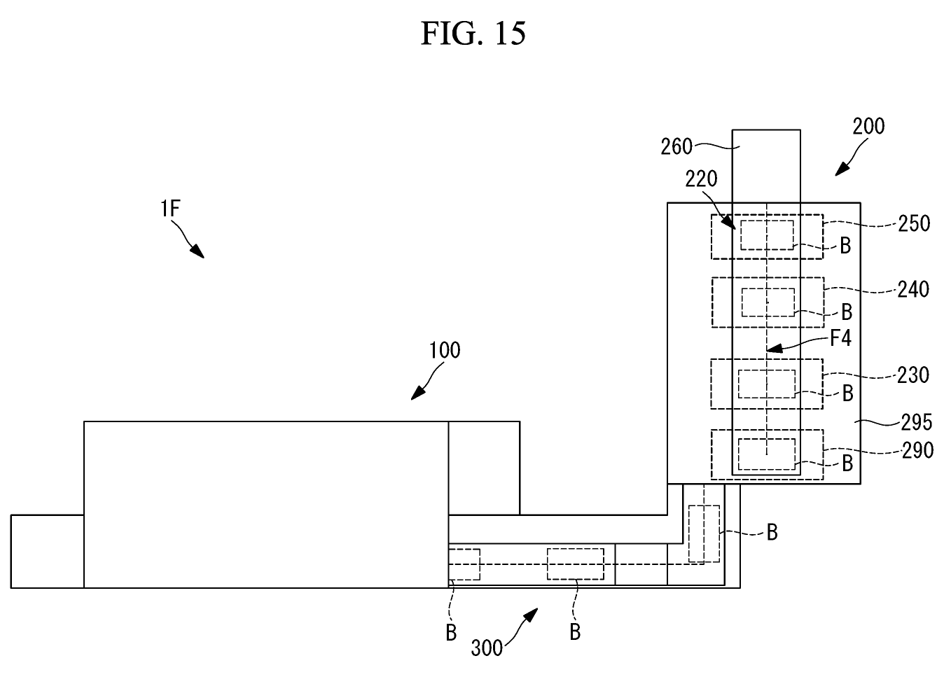

FIG. 14 is a plan view illustrating the bookbinding system 1F according to the seventh embodiment of the present disclosure, which is a diagram illustrating the first transport path F3 of the cutting apparatus 200. FIG. 15 is a plan view illustrating the bookbinding system 1F according to the seventh embodiment of the present disclosure, which is a diagram illustrating a second transport path F4 of the cutting apparatus 200.

As illustrated in FIG. 14 and FIG. 15, the cutting apparatus 200 has a first transport unit 210, a second transport unit 220, a fore edge cutting unit 230, a top and tail cutting unit 240, a book discharge unit 250, a book supply unit 290, and a casing 295.

The first transport unit 210 is a device configured to transport, along the first transport path F3, the book B supplied from the transport apparatus 300 and supply the book B to the book supply unit 290. The first transport unit 210 has a conveyer belt 211 and a transport mechanism 212.

As illustrated in FIG. 14, the first transport unit 210 drives the conveyer belt 211 by the transport mechanism 212 and thereby transports the book B in one direction (clockwise in FIG. 14) along the first transport path F3. The first transport path F3 has a U-shape formed of the straight path F3a and the straight path F3b arranged spaced apart from each other in a vertical plane and each extending horizontally and of the arcuate path F3c connecting ends of the straight path F3a and the straight path F3b to each other.

As illustrated in FIG. 14, the first transport path F3 is longer than the straight-line distance L2 between a supply position Po3 at which the book B is supplied from the transport apparatus 300 to the first transport path F3 and a handover position Po4 at which the book B is handed over from the first transport path F3 to a book supply unit 290. The first transport path F3 is to turn the direction of transporting the book B by 180 degrees from the fourth direction DR4 on the straight path F3a back to the fifth direction DR5 on the straight path F3b to transport the book B.

As illustrated in FIG. 15, the second transport unit 220 is a device configured to transport, along the second transport path F4, the book B supplied from the first transport path F3 to the second transport path F4 by the book supply unit 290. When the cutting apparatus 200 is viewed from above in planar view, the second transport unit 220 is arranged above the first transport unit 210 so as to overlap the first transport unit 210.

The fore edge cutting unit 230 is a device configured to cut the fore edge of the book B transported from the book supply unit 290 by the second transport unit 220. The second transport unit 220 transports the book B whose fore edge has been cut by the fore edge cutting unit 230 to the top and tail cutting unit 240.

The top and tail cutting unit 240 is a device configured to cut the top and the tail of the book B transported from the fore edge cutting unit 230 by the second transport unit 220. The second transport unit 220 transports the book B whose top and tail have been cut by the top and tail cutting unit 240 to the book discharge unit 250.

The book discharge unit 250 is a device configured to discharge the book B whose three sides except for the spine of the book B have been cut to a discharge tray 260.

The book supply unit 290 is a device configured to supply the book B from the first transport path F3 to the second transport path F4. The book supply unit 290 moves the book B, which has been handed over from the first transport unit 210 on the first transport path F3, from below to above in the height direction and supplies the book B to the second transport path F4.

The casing 295 is a member that accommodates the first transport unit 210, the second transport unit 220, the fore edge cutting unit 230, the top and tail cutting unit 240, the book discharge unit 250, and the book supply unit 290 therein. The casing 295 is arranged so as to cover the entire region on the upper side of the first transport unit 210 and the entire region on the upper side of the second transport unit 220.

According to the bookbinding system 1F of the present embodiment, the first transport unit 210 and the second transport unit 220 are accommodated in the single casing 295 together with the fore edge cutting unit 230, the top and tail cutting unit 240, and the book supply unit 290. Further, the first transport path F3 is longer than the straight-line distance L2 between the supply position Po3 and the handover position Po4. Thus, the transport distance of the first transport path F3 is suitably ensured, and the glue on the spine of the book B can be sufficiently cooled before the book B is subjected to a cutting process by the fore edge cutting unit 230 and the top and tail cutting unit 240. Accordingly, the transport distance of the transport apparatus 300 configured to transport the book B from the bookbinding apparatus 100 to the cutting apparatus 200 can be shortened to achieve a reduction in size of the bookbinding system 1F.

### Other Embodiments

Although the first transport path F1 is arranged higher in the height direction HD than the second transport path F2 in the internal space of the casing 95 in the first to sixth embodiments described above, other forms may be employed. For example, the first transport path F1 may be arranged lower in the height direction HD than the second transport path F2.

In the first to sixth embodiments described above, as the bookbinding apparatus 100, those having a cooling unit configured to cool the book B transported along the second transport path F2 may be employed. As the cooling unit, for example, a blower configured to blow air toward the book B can be employed. Further, a heat sink configured to dissipate heat may be arranged in the space in which the second transport path F2 is arranged.

Although the second transport path F2 has a U-shape formed of the straight path F2a, the straight path F2b, and the arcuate path F2c connecting ends of the straight path F2a and the straight path F2b to each other in the first to sixth embodiments described above, other forms may be employed. For example, those having a plurality of straight paths combined may be employed. Further, a spirally wound path may be included. Further, a shape along which the book B is circulated over at least one or more rounds and then discharged to the transport apparatus 300 may be employed.

Although the second transport unit 20 transports the book B by the conveyer belt 21 and the transport roller 23 in the first to sixth embodiments described above, other forms may be employed. For example, those configured to move a book by rotating a plurality of balls in a particular direction or those configured to change the direction of the book B by rotating a disc may be employed. Further, those configured to transport the book B by a carrier that moves along a rail or those configured to transport the book B by a shuttle that floats and moves due to magnetism may be employed.

In the first embodiment, the second transport path F2 of the bookbinding apparatus 100 is longer than the straight-line distance L1 between the supply position Po1 and the discharge position Po2. Further, in the seventh embodiment, the first transport path F3 of the cutting apparatus 200 is longer than the straight-line distance L2 between the supply position Po3 at which the book B is supplied from the transport apparatus 300 to the first transport path F3 and the handover position Po4 at which the book B is handed over from the first transport path F3 to the book supply unit 290.

Further, the first embodiment and the seventh embodiment described above may be combined into another embodiment. Specifically, a bookbinding system may be such that the second transport path F2 of the bookbinding apparatus 100 is longer than the straight-line distance L1 between the supply position Po1 and the discharge position Po2 and that the first transport path F3 of the cutting apparatus 200 is longer than the straight-line distance L2 between the supply position Po3 at which the book B is supplied from the transport apparatus 300 to the first transport path F3 and the handover position Po4 at which the book B is handed over from the first transport path F3 to the book supply unit 290.

What is claimed is:

1. A bookbinding system comprising:
a bookbinding apparatus;
a cutting apparatus configured to perform a cutting process on a book bound by the bookbinding apparatus; and
a transport apparatus configured to transport, to the cutting apparatus, the book discharged from the bookbinding apparatus,
wherein the bookbinding apparatus has
a first transport unit configured to transport, along a first transport path, the book including a plurality of sheets,
a gluing unit configured to glue a spine of the book transported along the first transport path,
an attaching unit configured to attach an additional member to the spine of the book glued by the gluing unit,
a second transport unit configured to transport the book along a second transport path, the additional member being attached to the book by the attaching unit, and discharge the book to the transport apparatus,
a book supply unit configured to supply the book from the first transport path to the second transport path, the additional member being attached to the book, and
a casing configured to accommodate the first transport unit, the gluing unit, the attaching unit, the second transport unit, and the book supply unit, and
wherein the second transport path is longer than a straight-line distance between a supply position at which the book is supplied from the book supply unit to the second transport path and a discharge position at which the book is discharged from the second transport path to the transport apparatus.

2. The bookbinding system according to claim 1,
wherein the first transport path is to turn a direction of transporting the book from a first direction back to a second direction for transportation, the second direction being opposite to the first direction, and
wherein the second transport path is to turn a direction of transporting the book from the second direction back to the first direction for transportation.

3. The bookbinding system according to claim 1, wherein the first transport path and the second transport path are arranged such that at least partial regions of the first transport path and the second transport path overlap each other when the casing is viewed in planar view.

4. The bookbinding system according to claim 1, wherein the first transport path and the second transport path are arranged such that the second transport path surrounds the first transport path when the casing is viewed in planar view.

5. The bookbinding system according to claim 1, wherein the book supply unit has a motion mechanism configured to move the book in a height direction from the first transport path to the second transport path.

6. The bookbinding system according to claim 1, wherein the bookbinding apparatus has a cooling unit configured to cool the book transported along the second transport path.

7. The bookbinding system according to claim 1,
wherein the bookbinding apparatus has a discharge unit, the book being discharged from the second transport unit to the discharge unit, and
wherein the second transport unit discharges the book to either the transport apparatus or the discharge unit.

8. A bookbinding apparatus comprising:
a first transport unit configured to transport, along a first transport path, a book including a plurality of sheets;
a gluing unit configured to glue a spine of the book transported along the first transport path;
an attaching unit configured to attach an additional member to the spine of the book glued by the gluing unit;
a second transport unit configured to transport the book along a second transport path, the additional member being attached to the book by the attaching unit, and discharge the book;
a book supply unit configured to supply the book from the first transport path to the second transport path, the additional member being attached to the book; and
a casing configured to accommodate the first transport unit, the gluing unit, the attaching unit, the second transport unit, and the book supply unit, and
wherein the second transport path is longer than a straight-line distance between a supply position at which the book is supplied from the book supply unit to the second transport path and a discharge position at which the book is discharged from the second transport path.

9. A bookbinding system comprising:
a bookbinding apparatus;
a cutting apparatus configured to perform a cutting process on a book bound by the bookbinding apparatus; and
a transport apparatus configured to transport, to the cutting apparatus, the book discharged from the bookbinding apparatus,
wherein the cutting apparatus has
a first transport unit configured to transport, along a first transport path, the book supplied from the transport apparatus,
a second transport unit configured to transport the book along a second transport path,
a cutting unit configured to perform a cutting process on the book transported by the second transport unit,
a book supply unit configured to supply the book from the first transport path to the second transport path, and
a casing configured to accommodate the first transport unit, the second transport unit, the cutting unit, and the book supply unit, and
wherein the first transport path is longer than a straight-line distance between a supply position at which the book is supplied from the transport apparatus to the first transport path and a handover position at which the book is handed over from the first transport path to the book supply unit.
